(19) United States
(12) Patent Application Publication
(10) Pub. No.: US 2009/0244408 A1
(43) Pub. Date: Oct. 1, 2009

(54) Liquid crystal display device

(76) Inventor: Kentaro Kamada, Mie (JP)

Correspondence Address: HARNESS, DICKEY & PIERCE, P.L.C., P.O. BOX 8910, RESTON, VA, 20195, US

(21) Appl. No.: 12/310,981

(22) PCT Filed: Sep. 13, 2007
(86) PCT No.: PCT/JP2007/067859

§ 371 Date: Mar. 13, 2009

(30) Foreign Application Priority Data
Sep. 15, 2006 (JP) 2006-250291

(51) Int. Cl. H04N 3/14

(52) U.S. Cl. 348/790

(57) ABSTRACT

A liquid crystal display apparatus including a backlight with reduced power consumption is disclosed. The liquid crystal display apparatus according to one embodiment of the present invention includes a liquid crystal display panel, a backlight, and a backlight adjusting portion. To the liquid crystal display panel, an image signal of a certain channel selected from a plurality of channels of television broadcasting, or an image signal output from external equipment is input. The backlight emits light toward the liquid crystal display panel. The backlight adjusting portion turns off the backlight for a predetermined period of time when the selected channel is changed and/or when the input to the liquid crystal display panel is switched between the television broadcasting and the external equipment.

### TECHNICAL FIELD

The present invention relates to a liquid crystal display apparatus, and more particularly to a liquid crystal display apparatus provided with a backlight.

### BACKGROUND ART

A liquid crystal display apparatus is widely used in information equipment such as a portable personal computer, a mobile phone, and an electronic organizer, a camera built-in VTR furnished with a liquid crystal monitor, and the like by taking advantages of the thin body and low power consumption.

Recently, large-size flat panel displays (FPDs) are widely used, and hence liquid crystal televisions gain public attention. A liquid crystal television, i.e., a liquid crystal display apparatus which can receive television broadcasting is disclosed in Patent Documents 1 and 2, for example.

### Patent Document 1: Japanese Laid-Open Patent Publication No. 2004-302460

### Patent Document 2: Japanese Laid-Open Patent Publication No. 2005-172847

### DISCLOSURE OF INVENTION

### Problems to be Solved by the Invention

In these days, environmental issues are significantly considered, so that it is required for liquid crystal display apparatuses commencing with a liquid crystal television to further reduce the power consumption. In the power consumption of the whole liquid crystal display apparatus, since the proportion of the backlight in power consumption is large (specifically, about 60% to 80%), there is an urgent need to reduce the power consumption of the backlight.

The present invention has been conducted in view of the above-mentioned problems, and an object of the present invention is to provide a liquid crystal display apparatus including a backlight with reduced power consumption.

### Means for Solving the Problems

The liquid crystal display apparatus of the present invention is a liquid crystal display apparatus capable of receiving television broadcasting including: a liquid crystal display panel into which an image signal of a certain channel selected from a plurality of channels of television broadcasting or an image signal output from external equipment; a backlight for emitting light toward the liquid crystal display panel; and a backlight adjusting portion for turning off the backlight for a predetermined period of time when the selected channel is changed, and/or when the input into the liquid crystal display panel is switched between the television broadcasting and the external equipment, thereby attaining the above-mentioned object.

In a preferred embodiment, the plurality of channels include a channel of analog television broadcasting.

In a preferred embodiment, the plurality of channels include a channel of digital television broadcasting.

In a preferred embodiment, the plurality of channels include a channel of cable television broadcasting.

Alternatively, the liquid crystal display apparatus of the invention includes: a liquid crystal display panel into which an image signal is input; a backlight for emitting light toward the liquid crystal display panel; and a backlight adjusting portion for adjusting luminance of the backlight in accordance with a luminance level indicated by the image signal input into the liquid crystal display panel, thereby attaining the above-mentioned object.

In a preferred embodiment, the backlight adjusting portion lowers the luminance of the backlight than that in a normal state when the luminance level indicated by the image signal is lower than a predetermined level in an entire display area of the liquid crystal display panel.

In a preferred embodiment, the backlight adjusting portion turns off the backlight when the luminance level indicated by the image signal is lower than a predetermined level in the entire display area of the liquid crystal display panel.

In a preferred embodiment, the backlight adjusting portion turns off the backlight when the image signal is not input for a predetermined period.

### EFFECTS OF THE INVENTION

The liquid crystal display apparatus according to the present invention is provided with a backlight adjusting portion for turning off a backlight and for adjusting the luminance of the backlight.

Specifically, when a selected channel is changed, and/or an input to a liquid crystal display panel is switched between the television broadcasting and the external equipment, the backlight adjusting portion turns off the backlight for a predetermined period of time. In other words, the backlight adjusting portion turns off the backlight when the illumination light from the backlight is not necessary. Such a provision of the backlight adjusting portion reduces the power consumption of the backlight, so that the power consumption of the whole liquid crystal display apparatus can also be reduced.

Alternatively, the backlight adjusting portion adjusts the luminance of the backlight in accordance with the luminance level indicated by an image signal input to the liquid crystal display panel. Accordingly, when the luminance level of the image signal is low, the luminance of the backlight can be lowered. As a result, the power consumption of the backlight is reduced, so that the power consumption of the whole liquid crystal display apparatus can also be reduced.

### BRIEF DESCRIPTION OF DRAWINGS

FIG. 1 A block diagram schematically showing a liquid crystal display apparatus 100 in a preferred embodiment of the present invention.

FIG. 2 A view for illustrating the operation of backlight in the change of channels in a conventional liquid crystal display apparatus.

FIG. 3 A view for illustrating the operation of backlight in the change of channels in the liquid crystal display apparatus 100.

FIG. 4 A block diagram showing an example of a specific configuration for turning off the backlight in synchronization with the change of selected channels.

FIG. 5 A block diagram showing another example of a specific configuration for turning off the backlight in synchronization with the change of selected channels.

FIG. 6 A block diagram showing another example of a specific configuration for turning off the backlight in synchronization with the change of selected channels.

FIG. 7 A block diagram showing another example of a specific configuration for turning off the backlight in synchronization with the change of selected channels.

FIG. 8 A flowchart illustrating an example of a flow when a backlight adjusting portion controls the on/off of the backlight.

FIG. 9 A diagram schematically showing a liquid crystal display panel to which both of an image signal of television broadcasting and an image signal from external equipment can be input.

FIG. 10 A view for illustrating the operation of backlight in the change from the television broadcasting to the external input.

FIG. 11 A flowchart illustrating an example of a flow when the backlight adjusting portion controls the on/off of the backlight.

### DESCRIPTION OF REFERENCE NUMERALS

1 Liquid crystal display panel
2 Backlight
3 Backlight adjusting portion
4 Remote controller
10 Tuner
11 Control circuit
12 Operating portion
13 RC receiving portion
14 Image detecting circuit
15 Image amplifying circuit
16 Display portion
17 Sound detecting circuit
18 Sound amplifying circuit
19 Loudspeaker
20 Inverter
21 Light source
100 Liquid crystal display apparatus

### BEST MODE FOR CARRYING OUT THE INVENTION

Hereinafter, an embodiment of the present invention will be described with reference to the accompanying drawings. It is understood that the present invention is not limited to the following embodiments.

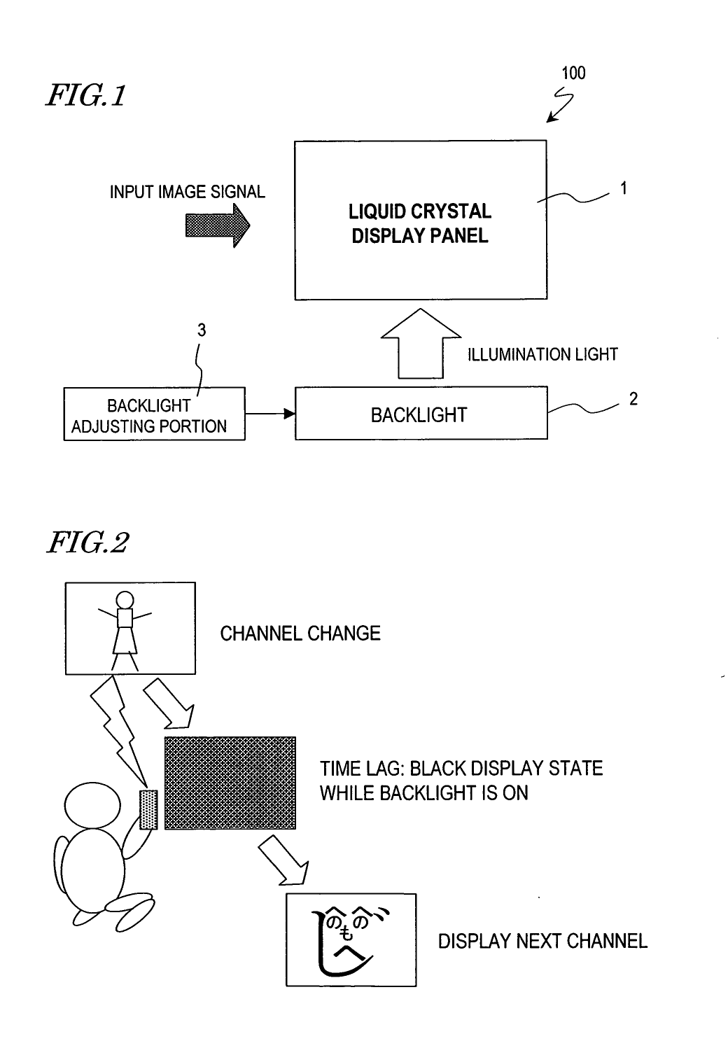

FIG. 1 schematically shows a liquid crystal display apparatus 100 in this embodiment. The liquid crystal display apparatus 100 is a liquid crystal television which can receive television broadcasting. The liquid crystal display apparatus 100 includes, as shown in FIG. 1, a liquid crystal display panel 1, a backlight 2, and a backlight adjusting portion 3.

To the liquid crystal display panel 1, image signals of a certain channel selected from a plurality of channels of television broadcasting (analog television broadcasting, digital television broadcasting, or cable television broadcasting, for example) are input. The liquid crystal display panel 1 typically includes a pair of substrates and a liquid crystal layer interposed between the substrates.

As display modes of the liquid crystal display panel 1, various display modes including TN (Twisted Nematic) mode, STN (Super Twisted Nematic) mode, IPS (In-Plane Switching) mode, VA (Vertical Alignment) mode, or other modes can be used.

The backlight 2 includes a light source for emitting light toward the liquid crystal display panel 1. The backlight 2 may be a direct type backlight, or an edge light type backlight having an optical waveguide. As the light source for the backlight, various light sources such as a cold cathode fluorescent tube (CCFL), or a light emitting diode (LED) can be employed.

The backlight adjusting portion 3 turns off the backlight 2 for a predetermined period of time when the selected channel is changed. Due to the provision of the backlight adjusting portion 3, the power consumption can be reduced without affecting the display of the liquid crystal display apparatus 100. Hereinafter the reason will be explained in detail.

In digital television broadcasting, compressed data (e.g. MPEG-2 format) is transmitted, so that a certain time is taken for decoding the data by a tuner. Accordingly, as shown in FIG. 2, there causes a time lag of about two seconds in changing the channels. In this time lag, any image is not displayed (i.e., in a black display state), but the backlight is still on in this time lag in a conventional liquid crystal display apparatus.

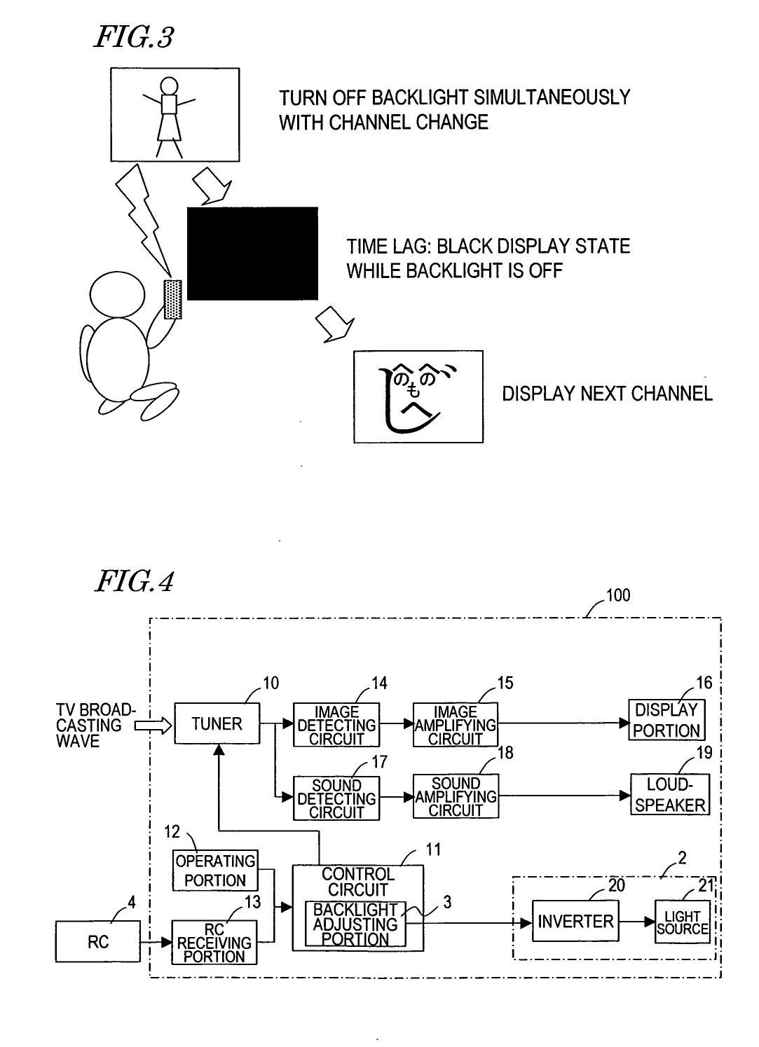

The backlight adjusting portion 3 in this embodiment turns off the backlight for a predetermined period of time, as shown in FIG. 3, when the selected channel is changed. Specifically, the backlight adjusting portion 3 turns off the backlight 2 when the illumination light from the backlight 2 is not required. Thus, the power consumption of the backlight can be reduced without affecting the display of the liquid crystal display apparatus 100. As a result, the power consumption of the whole liquid crystal display apparatus 100 can also be reduced. In addition, since the backlight 2 is turned off when the selected channel is changed, black-state light leakage in the time lag (in the black display state) can be prevented.

Next, an example of a specific configuration for turning off the backlight 2 in synchronization with the change of the selected channels will be described with reference to FIG. 4.

As shown in FIG. 4, the liquid crystal display apparatus 100 is remote-controlled by a remote controller (hereinafter referred to as an RC) 4. Specifically, ON/OFF of the power, the volume adjustment, the channel selection, and the like are performed via the RC 4.

The transmitted airwave of television broadcasting is first input into a tuner 10. The tuner 10 selectively receives the airwave of a desired channel, and converts or decodes the airwave into a signal of a specified frequency, thereby outputting the signal. The channels received by the tuner 10 are controlled by a control circuit 11. The control circuit 11 controls the tuner 10 in such a manner that the tuner 10 receives the channels input from an operating portion 12 or an RC receiving portion 13 for receiving the signal from the RC 4 disposed in the liquid crystal display apparatus 100.

After the signal output from the tuner 10 is detected by an image detecting circuit 14, the signal is amplified by an image amplifying circuit 15. The image signal output from the image amplifying circuit 15 is input into a display portion 16, and the display portion 16 displays the image.

The signal output from the tuner 10 is also input into a sound detecting circuit 17. After the signal from the tuner 10 is detected by the sound detecting circuit 17, the signal is amplified by a sound amplifying circuit 18. The sound signal output from the sound amplifying circuit 18 is input into a loudspeaker 19, and the loudspeaker 19 reproduces the sound.

The control circuit 11 includes the backlight adjusting portion 3, so as to control the on/off of an inverter 20 of the backlight 2. The control circuit 11 with the backlight adjusting portion 3 keeps on the inverter 20 in a normal state, and turns off the inverter 2 for a predetermined period of time when the selected channel is changed (i.e., when a signal indicating the change of channel is output from the operating portion 12 or the RC receiving portion 13). A light source 21 of the backlight 2 is turned on/off in accordance with the on/off of the inverter 20. Thus, the on/off of the backlight 2 is controlled. The period of time for which the backlight 2 is turned off in the change of the selected channels is appropriately determined depending on the specifications of the tuner 10 and the like. For example, the backlight 2 may be turned off for a period of time required for decoding the compressed data transmitted in the digital television broadcasting by the tuner 10.

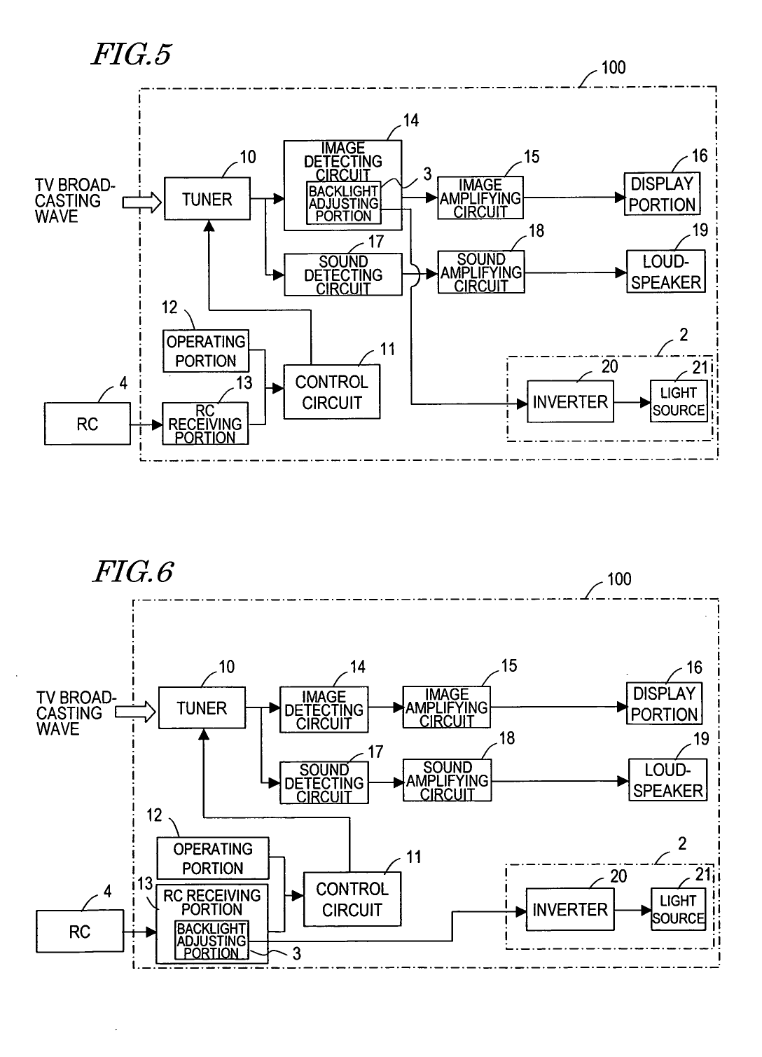

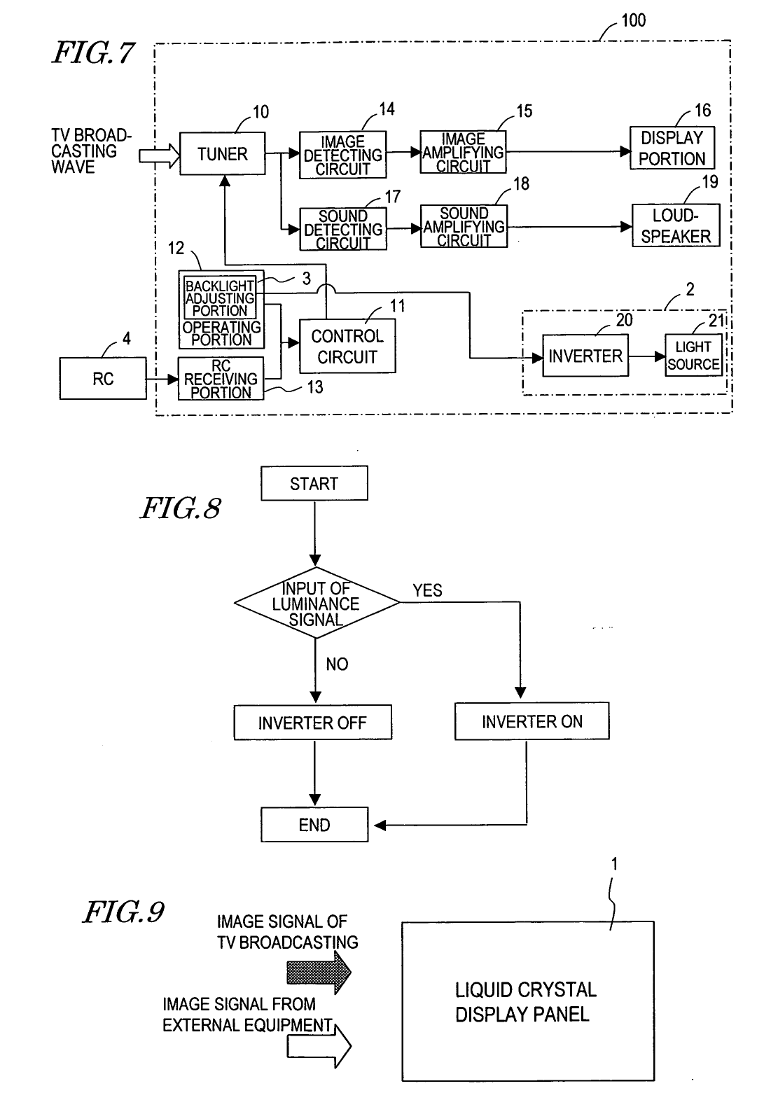

In the example shown in FIG. 4, the control circuit 11 includes the backlight adjusting portion 3, but the present invention is not limited to this configuration. The backlight adjusting portion 3 may be included in the image detecting circuit 14, the RC receiving portion 13, the operating portion 12, or the like, as shown in FIGS. 5, 6, and 7.

FIG. 8 shows an example of a flow when the backlight adjusting portion 3 controls the on/off of the backlight 2. In the example shown in FIG. 8, the backlight adjusting portion 3 controls the on/off of the inverter 20 in accordance with the presence/absence of the input of a luminance signal, thereby controlling the on/off of the backlight 2.

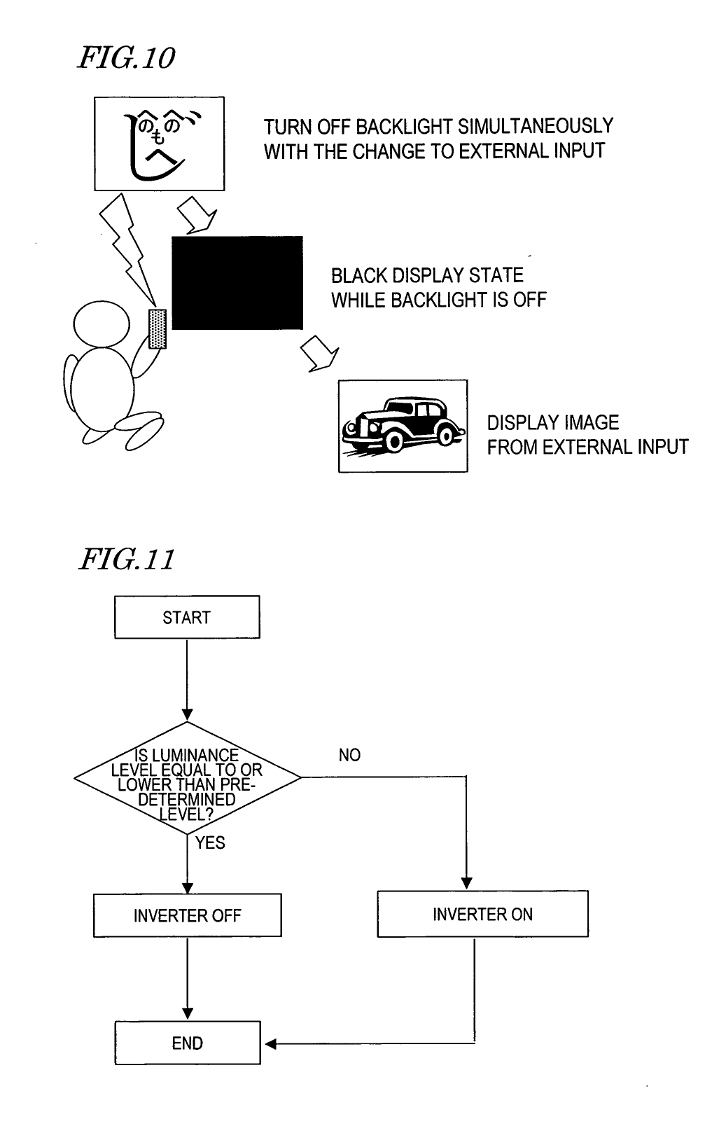

In the above description, the example in which only the image signal of television broadcasting is input into the liquid crystal display panel 1 is explained. However, as shown in FIG. 9, an image signal output from external equipment such as a DVD player or an HDD recorder may be input into the liquid crystal display panel 1. In such a case, as shown in FIG. 10, when the input to the liquid crystal display panel 1 is switched between the television broadcasting and the external equipment, the backlight 2 may be turned off for a predetermined period of time.

For example, even when the input is switched from the television broadcasting to the external equipment, in some cases, the power of the external equipment may be in the off state, or a reproduction button of the external equipment may not be depressed. Thus, the display based on the external input is not necessarily performed immediately. Accordingly, when the input into the liquid crystal display panel 1 is switched between the television broadcasting and the external equipment, the backlight 2 is turned off for a predetermined period of time (e.g., until the input of the image signal from the external equipment to the liquid crystal display panel 1 is actually started). Thus, the power consumption can be reduced.

As described above, at least one of the case where the selected channel is changed and the case where the input into the liquid crystal display panel 1 is switched between the television broadcasting and the external equipment, the backlight adjusting portion 3 turns off the backlight 2. Thus, the power consumption of the liquid crystal display apparatus 100 can be reduced.

The backlight adjusting portion 3 may adjust the luminance of the backlight 2 in accordance with the luminance level indicated by the image signal input into the liquid crystal display panel 1. For example, the backlight adjusting portion 3 may lower the luminance of the backlight 2 than that in the normal state, or may turn off the backlight 2 when the luminance level of the image signal is lower than a predetermined level in the entire display area of the liquid crystal display panel 1 (e.g., in a solid-black display in which the luminance level is 5% or less of the level in the white display). By the provision of such a backlight adjusting portion 3, the power consumption can be reduced.

FIG. 11 shows an example of a flow when such a backlight adjusting portion 3 controls the on/off of the backlight 2. In the example shown in FIG. 11, the backlight adjusting portion 3 controls the on/off of the inverter 20 depending on the judgment whether the luminance level is a predetermined level or less (e.g. 5% of the level in the white display or less). Thus, the on/off of the backlight 2 is controlled.

The backlight adjusting portion 3 which can adjust the luminance of the backlight 2 in accordance with the luminance level of the image signal can be disposed in the image detecting circuit 14 or in the image amplifying circuit 15, for example.

The backlight adjusting portion 3 may turn off the backlight 2 when the image signal is not input for a predetermined period of time (e.g., after the end of the television broadcasting). Accordingly, the power consumption can be further reduced.

### INDUSTRIAL APPLICABILITY

According to the present invention, a liquid crystal display apparatus including a backlight with reduced power consumption can be provided. Because of the low power consumption, the liquid crystal display apparatus according to the present invention can be suitably used as a display device for various types of electronic equipment such as a liquid crystal television.

1. A liquid crystal display apparatus capable of receiving television broadcasting comprising:
a liquid crystal display panel into which an image signal of a certain channel selected from a plurality of channels of television broadcasting or an image signal output from external equipment;
a backlight for emitting light toward the liquid crystal display panel; and
a backlight adjusting portion for turning off the backlight for a predetermined period of time when the selected channel is changed, and/or when the input into the liquid crystal display panel is switched between the television broadcasting and the external equipment.

2. The liquid crystal display apparatus of claim 1, wherein the plurality of channels include a channel of analog television broadcasting.

3. The liquid crystal display apparatus of claim 1, wherein the plurality of channels include a channel of digital television broadcasting.

4. The liquid crystal display apparatus of claim 1, wherein the plurality of channels include a channel of cable television broadcasting.

5. A liquid crystal display apparatus comprising:
a liquid crystal display panel into which an image signal is input;
a backlight for emitting light toward the liquid crystal display panel; and
a backlight adjusting portion for adjusting luminance of the backlight in accordance with a luminance level indicated by the image signal input into the liquid crystal display panel.

6. The liquid crystal display apparatus of claim 5, wherein the backlight adjusting portion lowers the luminance of the backlight than that in a normal state when the luminance level indicated by the image signal is lower than a predetermined level in an entire display area of the liquid crystal display panel.

7. The liquid crystal display apparatus of claim 6, wherein the backlight adjusting portion turns off the backlight when the luminance level indicated by the image signal is lower than a predetermined level in the entire display area of the liquid crystal display panel.

8. The liquid crystal display apparatus of claim 5, wherein the backlight adjusting portion turns off the backlight when the image signal is not input for a predetermined period.
